(19) United States
(12) Patent Application Publication
(10) Pub. No.: US 2006/0287278 A1
(43) Pub. Date: Dec. 21, 2006

(54) Method for improving water solubility of chitosan

(76) Inventors: Zhenze Hu, Pittsford, NY (US); Erning Xia, Penfield, NY (US)

Correspondence Address: Bausch & Lomb Incorporated, One Bausch & Lomb Place, Rochester, NY, 14604-2701, US

(21) Appl. No.: 11/472,236

(22) Filed: Jun. 21, 2006

Related U.S. Application Data
(60) Provisional application No. 60/692,353, filed on Jun. 21, 2005.

(51) Int. Cl. A01N 43/04; A01N 37/44; A01N 37/12

(52) U.S. Cl. 514/55; 536/20; 514/237.5; 514/252.12; 514/566

(57) ABSTRACT

The present invention is directed to a composition comprising: (a) at least one nonderivatized chitosan and (b) at least one solubilizing buffer, as well as methods of preserving contact lens solutions and disinfecting contact lens using such composition.

### CROSS REFERENCE

This application claims the benefit of Provisional Patent Application No. 60/692,353 filed Jun. 21, 2005 and is incorporated herein by reference.

### FIELD OF THE INVENTION

The present invention relates to a method of preparing clear solutions of nonderivatized chitosan at near neutral pH. Such solutions are preferable for physiological applications. Also provided are novel compositions containing nonderivatized chitosan and a solubility enhancing amount of buffer. The compositions are useful as carriers for ophthalmic medication, tear substitutes, antimicrobial additives, etc.

### BACKGROUND OF THE INVENTION

Ophthalmic products intended for repeated use after opening, that is “multi-dose” products, must be preserved to minimize contamination with microorganisms during use. Preservatives that are used in ophthalmic solutions are often irritating to the eye, and, at worst, may damage eye tissue after repeated use. Preservative problems may be worsened in contact lens solutions when a contact lens that has been exposed to a preservative in a lens care solution acts as a reservoir that concentrates the preservative in the eye.

In the United States, acceptably preserved pharmaceutical products, including ophthalmic, nasal and otic preparations, must achieve minimum performance standards when tested according to the procedures of the United States Pharmacopoeia Preservative Efficacy Test (PET). According to the PET protocol, adequately preserved formulations must reduce 0 day challenge inocula and 14 day re-challenge inocula of the bacteria Staphylococcus aureus, Pseudomonas aeruginosa and Escherichia coli by at least 99.99% (3 logs) within 14 and 28 days after the challenge date. In the fungal challenge portion of the PET, preserved formulations must not allow any growth of Aspergillus niger and Candida albicans within 14 and 28 days following the 0 day challenge. To demonstrate preservative efficacy for contact lens care products, a modified PET procedure is required by the FDA wherein a re-challenge of the test solutions is done on day 14 after the 14 day organism concentrations are determined.

Chitosan, the de-acetylation product of chitin, is a non-toxic biopolymer with weak antimicrobial activity. In the past, the use of chitosan to preserve pharmaceutical compositions has been hampered by its insolubility at pH above 6 and also because the antimicrobial activity of chitosan in acidic solutions, by itself, is too low to meet PET requirements. It is well known that solutions of chitosan provide transparent solutions or hydrogels up to pH 6.0-6.5 with the chitosan forming a precipitate at pH conditions near neutral, i.e., pH ˜7.0. Also, chitosans having higher molecular weight and low deacetylation degree (<60%) give near neutral hydrogels (pH 7.1) when dissolved. However, the relatively high viscosity of these chitosan solutions limits their usefulness for ophthalmic applications. Additionally, higher molecular weight chitosans have shown increased degree of irritation. It is also known that chitosan's water solubility at near neutral pH can be improved by derivatization with hydrophilic functional groups, such as carboxymethyl or glycol substituents, or by selective N-acetylation of commercially available chitosans. However, derivatization of chitosan may interfere with its functionality.

Considerable efforts have been made to extend the water solubility of chitosan at near neutral pH. In Sannan et al., Makromol Chem. 177, 35899 (1976), it was reported that, by treating chitin with alkali under homogeneous conditions, chitin with about 50% deacetylation became water-soluble. However, long reaction time and large quantities of solvent are required in some stages, including neutralization of the reaction mixture and removal of the resulting salt. This laborious process would be troublesome especially in large-scale production.

Kurita et al., Carbohydrate Polymers 16, 83 (1991), also discloses preparing water-soluble chitosan with about 50% N-acetylation. However, the complex solvent system, aqueous acetic acid/methanol/lpyridine, and especially the huge excess of pyridine, made this process impractical. Furthermore, it has been reported that samples prepared according to Kurita's process have very poor solubility in water at neutral pH value.

Kubota et al., Polymer Journal 29, 123 (1997), reported a facile preparation of water-soluble N-acetylated chitosan. In this reference, the chitosan is degraded by treatment with NaBO₃, and the depolymerized product is then N-acetylated with acetic anhydride in aqueous acetic acid. Since both physical-chemical and biological properties of chitosan are dependent upon the chemistry of the polymer, such as the random distribution of a definite amount of acetyl groups and the molecular weight of the polymer, this process, which involves depolymerization, might alter the biological properties of chitosan.

U.S. patent appl. Ser. No. 10/045,959 describes methods of randomly derivatizing chitosan to provide a soluble chitosan or chitosan derivative. The chitosan or chitosan derivative of this method is prepared by dissolving the chitosan or chitosan derivative into an aqueous acidic solution and reacting the chitosan with an acetylating agent in the presence of a phase transfer reagent. This approach is costly, employs hazardous chemicals, and may undesirably alter the functionality of the chitosan.

For at least the above reasons, an efficient method of providing a soluble nonderivatized chitosan at near neutral pH would be desirable.

### SUMMARY OF INVENTION

The present invention is directed to a method of providing compositions comprising: (a) nonderivatized chitosan, and (b) a solubility enhancing amount of buffer solution selected from the group consisting of solutions comprising boric acid, solutions comprising sodium borate, solutions comprising potassium tetraborate, solutions comprising potassium metaborate, solutions comprising tris (hydoxymethyl)aminoethane, solutions comprising Good buffers including N,N-Bis(2-hydroxyethyl)-2-aminoethanesulfonic acid (BES), N,N-Bis(2-hydroxyethyl)glycines (BICINE), 3-(Cyclohexylamino)-1-propanesulfonic acid (4-(2-Hydroxyethyl)-1-piperazinepropanesulfonic acid (EPPS), 4-(2-Hydroxyethyl)piperazine-1-ethanesulfonic acid (HEPES), 2-(N-Morpholino)ethanesulfonic acid hydrate (MES), morpholinopropanesulfonic acid (MOPS), 1,4-Piperazinediethanesulfonic acid (PIPES), [(2-Hydroxy-1,1-bis(hydroxymethyl)ethyl)amino]-1-propanesulfonic acid (TAPS), 2-[(2-Hydroxy-1,1-bis(hydroxymethyl)ethyl)amino]ethanesulfonic acid (TES), and N-[Tris(hydroxymethyl)methyl]glycines (TRICINE); solutions comprising EDTA and mixtures thereof. The present invention is further directed to a method of preserving a contact lens solution, comprising mixing a contact lens solution with the composition comprising: (a) nonderivatized chitosan, and (b) a solubility enhancing amount of buffer solution selected from the group consisting of solutions comprising boric acid, solutions comprising sodium borate, solutions comprising potassium tetraborate, solutions comprising potassium metaborate, solutions comprising tris (hydoxymethyl)aminoethane, solutions comprising Good buffers including N,N-Bis(2-hydroxyethyl)-2-aminoethanesulfonic acid (BES), N,N-Bis(2-hydroxyethyl)glycines (BICINE), 3-(Cyclohexylamino)-l-propanesulfonic acid (4-(2-Hydroxyethyl)-1-piperazinepropanesulfonic acid (EPPS), 4-(2-Hydroxyethyl)piperazine-1-ethanesulfonic acid (HEPES), 2-(N-Morpholino)ethanesulfonic acid hydrate (MES), morpholinopropanesulfonic acid (MOPS), 1,4-Piperazinediethanesulfonic acid (PIPES), [(2-Hydroxy-1,1-bis(hydroxymethyl)ethyl)amino]-1-propanesulfonic acid (TAPS), 2-[(2-Hydroxy-1,1-bis(hydroxymethyl)ethyl)amino]ethanesulfonic acid (TES), and N-[Tris(hydroxymethyl)methyl]glycines (TRICINE); solutions comprising EDTA and mixtures thereof. Tonicity modifying agents and viscosity modifying agents may be added to provide a clear hypotonic solution of chitosan at near neutral pH.

Additional aspects of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

FIG. 1 is a graphical representation of the pH dependent solubility profile of nonderivatized chitosan in borate buffered saline.

FIG. 2 is a graphical representation of the pH dependent solubility profile of nonderivatized chitosan in Tris buffer solution.

FIG. 3 is a graphical representation of the pH dependent solubility profile of nonderivatized chitosan in MOPS buffer solution.

FIG. 4 is a graphical representation of the pH dependent solubility profile of nonderivatized chitosan in phosphate buffer solution.

FIG. 5 is a graphical representation of the pH dependent solubility profile of nonderivatized chitosan in citric acid buffer solution.

### DETAILED DESCRIPTION

The present invention may be understood more readily by reference to the following detailed description of preferred embodiments of the invention and the examples included herein.

Before the present compounds, compositions, articles, devices, and/or methods are disclosed and described, it is to be understood that the terminology used herein is for the purpose of describing particular embodiments only and is not intended to be limiting.

References in the specification and concluding claims to parts by weight of a particular element or component in a composition or article denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5 and are present in such ratio regardless of whether additional components are contained in the compound.

A weight percent of a component, unless specifically stated to the contrary, is based on the total weight of the formulation or composition in which the component is included.

In this specification and in the claims that follow, reference will be made to a number of terms that shall be defined to have the following meanings:

By the term “effective amount”, or words of like import, of a compound or property as provided herein is meant such amount as is capable of performing the function of the compound or property for which an effective amount is expressed. The exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation.

The expression “solubility enhancing”, or words of like import, refers to an amount of buffer that allows nonderivatized chitosan to be soluble at near neutral pH.

By “near neutral” pH, or words of like import, it is meant that the pH of the solution is between about 6.5 and about 8.0.

By “pharmaceutically acceptable”, or words of like import, is meant a material that is not biologically or otherwise undesirable, i.e., the material may be administered to an individual without causing any undesirable biological effects or interacting in a deleterious manner with any of the other components of the pharmaceutical composition in which it is contained.

The present invention comprises a composition useful, for example, for pharmaceutical products. The composition can also be used in various ophthalmic products such as contact lens rinsing, lubricating, cleaning and storage solutions, artificial tear solutions and ophthalmic drugs. The compositions of the instant invention may also be used in otic and nasal solutions.

Contact lens solutions in particular present a special challenge because lens wearers are usually exposed to the preserving agents for many years on a daily basis. The possibility that the lens wearer can experience discomfort or develop sensitivity to the preservative is even higher than would be the case in short-term exposure. Typical contact lens solution preserving agents used in the prior art are sorbic acid, thimerosal, or DYMED® (polyaminopropyl biguanide).

The composition of this invention comprises nonderivatized chitosan and a solubility enhancing amount of buffer solution selected from the group consisting of solutions comprising boric acid, solutions comprising sodium borate, solutions comprising potassium tetraborate, solutions comprising potassium metaborate, solutions comprising tris (hydoxymethyl)aminoethane, solutions comprising Good buffers including N,N-Bis(2-hydroxyethyl)-2-aminoethanesulfonic acid (BES), N,N-Bis(2-hydroxyethyl)glycines (BICINE), 3-(Cyclohexylamino)-1-propanesulfonic acid (4-(2-Hydroxyethyl)-1-piperazinepropanesulfonic acid (EPPS), 4-(2-Hydroxyethyl)piperazine-1-ethanesulfonic acid (HEPES), 2-(N-Morpholino)ethanesulfonic acid hydrate (MES), morpholinopropanesulfonic acid (MOPS), 1,4-Piperazinediethanesulfonic acid (PIPES), [(2-Hydroxy-1,1-bis(hydroxymethyl)ethyl)amino]-1-propanesulfonic acid (TAPS), 2-[(2-Hydroxy-1,1-bis(hydroxymethyl)ethyl)amino]ethanesulfonic acid (TES), and N-[Tris(hydroxymethyl)methyl]glycines (TRICINE); solutions comprising EDTA and mixtures thereof. The composition of this invention additionally may contain at least one biocidal adjuvant. Compositions of the present invention contain these components in amounts to be effective as pharmaceutical preserving compositions useful for preserving pharmaceutical products, including ophthalmic, nasal and otic preparations.

Nonderivatized chitosan is partial N-, partial O-acetylated chitin that has not undergone further derivatization reaction. This is in contrast to derivatized chitosans such as water-soluble chitosan, water-soluble O-acetylated chitosan, chitosan oligosaccharide, carboxymethyl chitosan, and hydroxyalkyl chitosans, for example, hydroxyethyl chitosan (also known as glycol chitosan), hydroxypropyl chitosan, dihydroxypropyl chitosan, hydroxybutyl chitosan and dihydroxybutyl chitosan. It has surprisingly been discovered that acidified solutions of nonderivatized chitosan, when in the presence of a solubility enhancing amount of buffer, can be brought to near neutral pH without precipitation of the chitosan.

One preferred embodiment may be used as a contact lens solution preservative. Another preferred embodiment may be used as a contact lens disinfection regimen. When the composition comprised of nonderivatized chitosan and a solubility enhancing amount of buffer solution selected from the group consisting of solutions comprising boric acid, solutions comprising sodium borate, solutions comprising potassium tetraborate, solutions comprising potassium metaborate, solutions comprising tris (hydoxymethyl)aminoethane, solutions comprising Good buffers including N,N-Bis(2-hydroxyethyl)-2-aminoethanesulfonic acid (BES), N,N-Bis(2-hydroxyethyl)glycines (BICINE), 3-(Cyclohexylamino)-1-propanesulfonic acid (4-(2-Hydroxyethyl)-1-piperazinepropanesulfonic acid (EPPS), 4-(2-Hydroxyethyl)piperazine-1-ethanesulfonic acid (HEPES), 2-(N-Morpholino)ethanesulfonic acid hydrate (MES), morpholinopropanesulfonic acid (MOPS), 1,4-Piperazinediethanesulfonic acid (PIPES), [(2-Hydroxy-1,1-bis(hydroxymethyl)ethyl)amino]-1-propanesulfonic acid (TAPS), 2-[(2-Hydroxy-1,1-bis(hydroxymethyl)ethyl)amino]ethanesulfonic acid (TES), and N-[Tris(hydroxymethyl)methyl]glycines (TRICINE); solutions comprising EDTA and mixtures thereof is used in a method to preserve a contact lens solution, the contact lens solution is mixed with the composition. When the composition comprised of nonderivatized chitosan and a solubility enhancing amount of buffer solution selected from the group consisting of solutions comprising boric acid, solutions comprising sodium borate, solutions comprising potassium tetraborate, solutions comprising potassium metaborate, solutions comprising tris (hydoxymethyl)aminoethane, solutions comprising Good buffers including N,N-Bis(2-hydroxyethyl)-2-aminoethanesulfonic acid (BES), N,N-Bis(2-hydroxyethyl)glycines (BICINE), 3-(Cyclohexylamino)-1-propanesulfonic acid (4-(2-Hydroxyethyl)-1-piperazinepropanesulfonic acid (EPPS), 4-(2-Hydroxyethyl)piperazine-1-ethanesulfonic acid (HEPES), 2-(N-Morpholino)ethanesulfonic acid hydrate (MES), morpholinopropanesulfonic acid (MOPS), 1,4-Piperazinediethanesulfonic acid (PIPES), [(2-Hydroxy-1,1-bis(hydroxymethyl)ethyl)amino]-1-propanesulfonic acid (TAPS), 2-[(2-Hydroxy-1,1-bis(hydroxymethyl)ethyl)amino]ethanesulfonic acid (TES), and N-[Tris(hydroxymethyl)methyl]glycines (TRICINE); solutions comprising EDTA and mixtures thereof is used in a contact lens disinfection regimen, the contact lens is rinsed and rubbed with the composition, and the contact lens then soaks in the composition for a suitable period of time, such as not less than 15 minutes, more preferably for not less than 1 hour, even more preferably not less than four hours. Preferably, the soaking occurs at room temperature; however, any suitable temperature may be employed.

In a preferred embodiment, the nonderivatized solubilized chitosan of the present invention has the additional advantage of being capable of performing several functions normally requiring other ingredients. For instance, in a preferred embodiment, the nonderivatized solubilized chitosan may, in addition to its preserving role, act as a natural surfactant and aid in lens cleaning by emulsifying lens proteins and lipids away from the lens surface into solution. Furthermore, nonderivatized solubilized chitosan, as a polysaccharide, can be used in a preferred embodiment as a solution thickening agent and lens lubricant, thereby enhancing lens comfort by reducing lens drying rate. As such, the nonderivatized solubilized chitosan in one embodiment of this invention has a demulcent effect so as to enhance lens wearer comfort.

The solubility enhancing buffer system, solid or solution, includes, but is not limited to, boric acid, sodium borate, potassium tetraborate, potassium metaborate, tris (hydoxymethyl)aminoethane, Good buffers including N,N-Bis(2-hydroxyethyl)-2-aminoethanesulfonic acid (BES), N,N-Bis(2-hydroxyethyl)glycines (BICINE), 3-(Cyclohexylamino)-1-propanesulfonic acid (4-(2-Hydroxyethyl)-1-piperazinepropanesulfonic acid (EPPS), 4-(2-Hydroxyethyl)piperazine-1-ethanesulfonic acid (HEPES), 2-(N-Morpholino)ethanesulfonic acid hydrate (MES), morpholinopropanesulfonic acid (MOPS), 1,4-Piperazinediethanesulfonic acid (PIPES), [(2-Hydroxy-1,1-bis(hydroxymethyl)ethyl)amino]-1-propanesulfonic acid (TAPS), 2-[(2-Hydroxy-1,1-bis(hydroxymethyl)ethyl)amino]ethanesulfonic acid (TES), and N-[Tris(hydroxymethyl)methyl]glycines (TRICINE); EDTA and mixtures thereof.

The present invention may include a biocidal adjuvant. The biocidal adjuvant may be used against, for example, bacteria, fungi, and viruses. Suitable biocidal adjuvants include, but are not limited to, disodium ethylenediaminetetracetic acid (EDTA), nitrilotriacetic acid, and ethyleneglycol-bis(β-amino-ethylether)-N,N-tetraacetic acid.

Compositions comprising the nonderivatized solubilized chitosan of the present invention may contain several ingredients to perform the intended function of the composition. One possible additional component may be used to allow the composition to have an osmotic pressure near that of normal lachrymal fluids. A tonicity agent, such as sodium chloride, potassium chloride or glycerol, may achieve such a function, for instance.

One feature of a preferred contact lens solution embodiment of the present invention is that proteins are stabilized against denaturing as compared to commercial multi-purpose contact lens solutions. In one embodiment, this effect may be accomplished by adding at least one surfactant to the composition. The surfactant may also aid in the cleaning of the lens. Typical surfactants include, but are not limited to, PLURONICS® or poloxamers, which are block copolymers of ethylene oxide and propylene oxide, or TETRONICS® or poloxamine, which are block copolymers resulting from addition of ethylene oxide and propylene oxide to ethylene diamine. Other surfactants that may be used in the invention include, but are not limited to, tyloxapol, octoxynols, nonoxynols, and TWEENS® or polyoxyethylene sorbitan fatty acid esters.

The contact lens solutions of the present invention may, in another embodiment, contain viscosity agents to provide lubrication to the eye. Typical viscosity agents include polysaccharides such as dextran, cellulose derivatives such as carboxymethyl cellulose and hydroxypropyl methylcellulose, as well as poly(vinyl alcohol), poly(N-vinylpyrrolidinone), poly(ethylene glycol), and glycerin.

The present nonderivatized solubilized chitosan compositions of the invention herein have at least minimal preserving activity. In one embodiment, the biocidal activity of the composition is sufficient to meet the performance criteria of the Preservative Efficacy Test (“PET”) of the USP (United States Pharmacopoeia) as modified by the FDA. As such, the present compositions will reduce 0 day challenge inocula and 14 day re-challenge inocula of the bacteria Staphylococcus aureus (ATCC No. 6538), Pseudomonas aeruginosa (ATCC No. 9027) and Escherichia coli (ATCC No. 8739) by at least 99.99% (3 logs) within 14 days after the challenge and re-challenge dates, each. In the fungal challenge portion of the PET, the present composition will not allow any growth of Aspergillus niger (ATCC No. 16404) and Candida albicans (ATCC No. 10231) within 14 days following a 0 day challenge and a 14 day re-challenge. As such, the present invention may be used in a method of preserving a contact lens solution, wherein the contact lens solution is mixed with the solubilized chitosan composition.

The nonderivatized solubilized chitosan containing compositions of the present invention has a near neutral pH. This pH condition is preferred for compatibility with the organism, such as the human eye. As such, one preferred pH of the invention is from 6 to 8, preferably 6.6 to 7.8, and more preferably 6.8 to 7.2. Insofar as the antimicrobial activity alone of the composition is concerned, the lowest pH in the specified range is preferred. Given such preferred pH ranges, the nonderivatized solubilized chitosan of the present invention is soluble at pharmaceutically acceptable pH levels.

The nonderivatized solubilized chitosan described in the present invention may be prepared by any method recognized in the art. Alternatively, water-soluble, nonderivatized partial N-, partial O-acetylated chitosan is prepared by dissolving the nonderivatized chitosan in an aqueous acidic solution and mixing with a solubility enhancing amount of borate buffer solution. The solubilizing buffer may be added as a solid or a solution. The solubilizing buffer solution may optionally contain several ingredients to perform the intended function of the composition. The acid used to form the aqueous acidic solutions can be a mineral or organic acid. Examples of acids would therefore include hydrochloric, sulfuric, citric acid, etc. The acidic solutions are relatively dilute with concentrations around one (1) Normal being entirely acceptable.

The solubility enhancing buffer comprises boric acid, sodium borate, potassium tetraborate, potassium metaborate, tris (hydoxymethyl)aminoethane, Good buffers including N,N-Bis(2-hydroxyethyl)-2-aminoethanesulfonic acid (BES), N,N-Bis(2-hydroxyethyl)glycines (BICINE), 3-(Cyclohexylamino)-1-propanesulfonic acid (4-(2-Hydroxyethyl)-1-piperazinepropanesulfonic acid (EPPS), 4-(2-Hydroxyethyl)piperazine-1-ethanesulfonic acid (HEPES), 2-(N-Morpholino)ethanesulfonic acid hydrate (MES), morpholinopropanesulfonic acid (MOPS), 1,4-Piperazinediethanesulfonic acid (PIPES), [(2-Hydroxy-1,1-bis(hydroxymethyl)ethyl)amino]-1-propanesulfonic acid (TAPS), 2-[(2-Hydroxy-1,1-bis(hydroxymethyl)ethyl)amino]ethanesulfonic acid (TES), and N-[Tris(hydroxymethyl)methyl]glycines (TRICINE);, EDTA and mixtures thereof.

The acidified solubilized buffered nonderivatized chitosan solutions can be neutralized with any suitable base, for example, sodium hydroxide. The osmotic pressure of the neutralized buffered solubilized nonderivatized chitosan solutions can be adjusted with any suitable tonicity agent, for example, sodium chloride.

This invention can be further illustrated by the following examples of various embodiments, although it should be understood that these examples are included merely for purposes of illustration and are not intended to limit the scope of the invention unless otherwise specifically indicated. The starting materials are commercially available unless otherwise described. All percentages are by weight unless otherwise described.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, percent is percent by weight, temperature is in ° C. or is at ambient temperature, and pressure is at or near atmospheric.

### Example 1

0.0726% Chitosan (84.5% deactylation), low MW (Fluka) in BBS

This solution was prepared by dissolving 0.456 chitosan in 300 g of distilled water plus 5 ml 1N HCl. After it had dissolved, the solution was mixed with 300 g of Borate buffer (1.7% Boric acid, 0.018% sodium borate). An amount of 1N NaOH solution was added to adjust the pH to 6.6. Sodium chloride was then added to adjust the osmotic pressure to 290 mOsm/kg.

### Comparative Example 1

0.0726% Chitosan (84.5% deactylation), low MW (Fluka) in PBS

This solution was prepared by dissolving 0.45 6 chitosan in 300 g of distilled water plus 5 ml 1N HCl. After it had dissolved, the solution was mixed with 300 g of Phosphate buffer (0.032% Sodium phosphate monobasic, 0.132% sodium phosphate dibasic, 0.88% sodium chloride). An amount of 1N NaOH solution was added to adjust the pH to 6.6. Sodium chloride was then added to adjust the osmotic pressure to 290 mOsm/kg.

Solubility Test

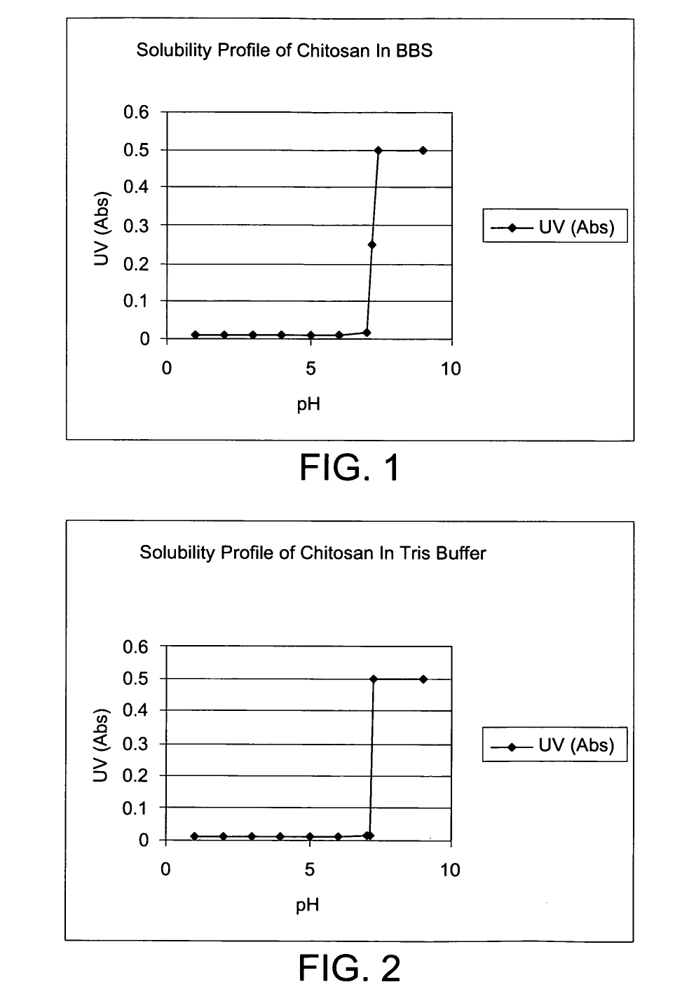

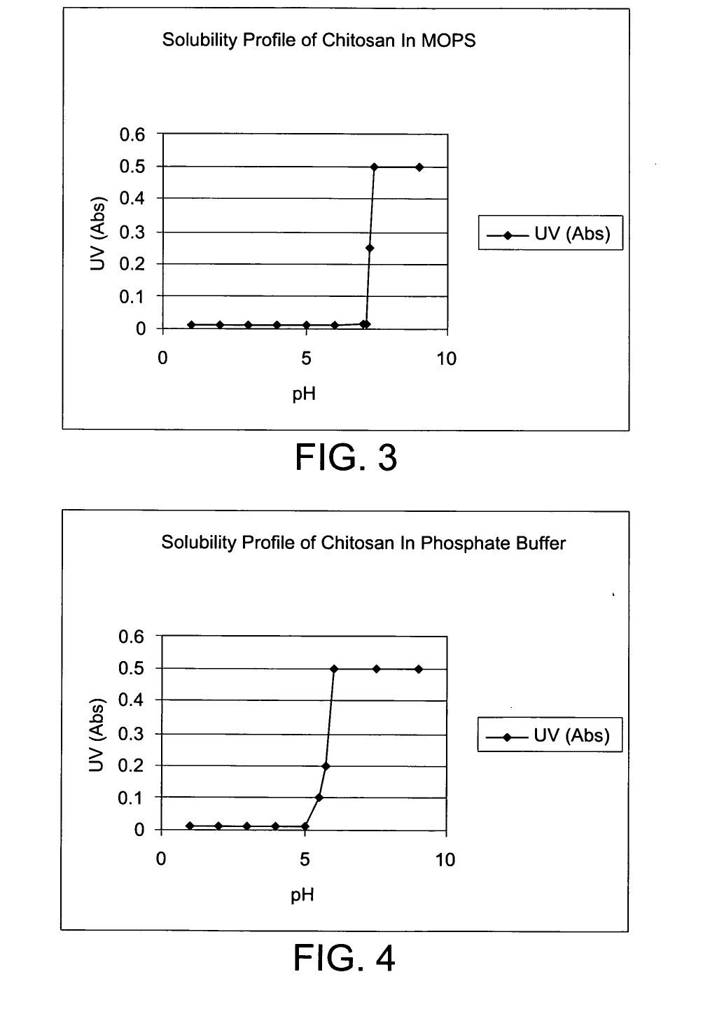

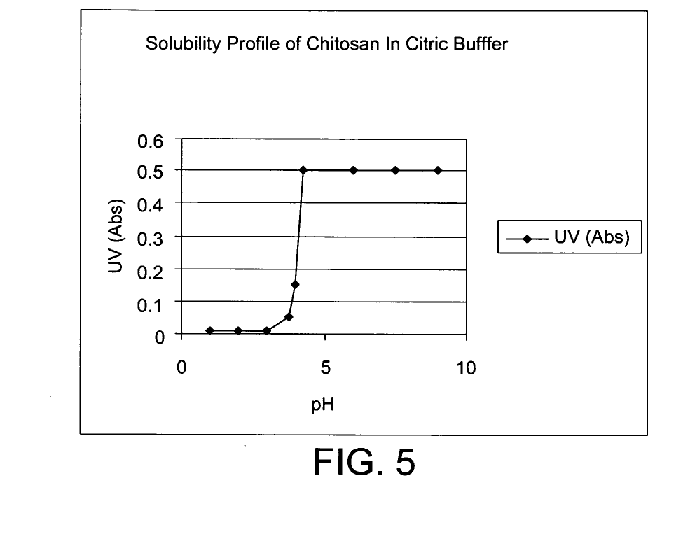

To determine the pH at which the above solutions were no longer soluble, the solutions were scanned using UV radiation. 0.1% Chitosan solution was prepared for this study for all buffer systems. The starting pH of chitosan solution was around 1-2 and the UV reading was around zero. Chitosan was precipitated from solution at different and higher pH (depending upon the buffer system). The UV reading is much higher (around 0.5 for 0.1% Chitosan). The results are found in FIGS. 1-5.

| Formulation | A | B |
|---|---|---|
| Composition | 0.0726 g Chitosan | 0.0726 g Chitosan |
| | 1N HCl | 1N HCl |
| | Borate buffer | Phosphate buffer |
| | NaCl | NaCl |
| | 1N NaOH | 1N NaOH |
| pH at which the solution | >7 | 6.6 |
| turns cloudy | | |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition comprising:
(a) a nonderivatized chitosan, and
(b) a solubility enhancing amount of a solubilizing buffer solution.
wherein the composition is soluble at near neutral pH.

2. The composition of claim 1, wherein the solubilizing buffer solution is selected from the group consisting of solutions comprising boric acid, solutions comprising sodium borate, solutions comprising potassium tetraborate, solutions comprising potassium metaborate, solutions comprising tris (hydoxymethyl)aminoethane, solutions comprising Good buffers including N,N-Bis(2-hydroxyethyl)-2-aminoethanesulfonic acid (BES), N,N-B is(2-hydroxyethyl)glycines (BICINE), 3-(Cyclohexylamino)-1-propanesulfonic acid (4-(2-Hydroxyethyl)-1-piperazinepropanesulfonic acid (EPPS), 4-(2-Hydroxyethyl)piperazine-1-ethanesulfonic acid (HEPES), 2-(N-Morpholino)ethanesulfonic acid hydrate (MES), morpholinopropanesulfonic acid (MOPS), 1,4-Piperazinediethanesulfonic acid (PIPES), [(2-Hydroxy-1,1-bis(hydroxymethyl)ethyl)amino]-1-propanesulfonic acid (TAPS), 2-[(2-Hydroxy-1,1-bis(hydroxymethyl)ethyl)amino]ethanesulfonic acid (TES), and N-[Tris(hydroxymethyl)methyl]glycines (TRICINE); solutions comprising EDTA and mixtures thereof.

3. The composition of claim 1, further comprising at least one biocidal adjuvant.

4. The composition of claim 3, wherein the at least one biocidal adjuvant comprises EDTA.

5. The composition of claim 1, wherein the pH of the composition is from about 6.5 to about 8.0.

6. The composition of claim 1, further comprising at least one surfactant.

7. A contact lens solution comprising the composition of claim 1.

8. A contact lens solution comprising the product formed from mixing components a and b of claim 1.

9. A pharmaceutical preserving composition comprising the product formed from mixing components a and b of claim 1.

10. A method of preserving a contact lens solution, comprising mixing a contact lens solution with a preservative effective amount of the composition of claim 1.

11. The method of claim 10, wherein components a and b are present in an amount such that the bacteria Staphylococcus aureus, Pseudomonas aeruginosa and Escherichia coli are reduced by at least 99.99% (3 logs) within 14 days after the challenge and re-challenge dates, each.

12. The method of claim 10, wherein components a and b are present in an amount such that the growth of Aspergillus niger and Candida albicans is not allowed within 14 days after the challenge and re-challenge dates.

13. A method of disinfecting a contact lens, comprising soaking the contact lens with a solution comprising the composition of claim 1 for a suitable period of time.

14. The method of claim 14, further comprising rubbing and rinsing the contact lens with a solution comprising the composition of claim 1.

15. A process for producing an aqueous nonderivatized chitosan, comprising the steps of dissolving a chitosan in an aqueous acidic solution and mixing the chitosan with a solubilizing amount of a solubilizing buffer system.

16. The process of claim 18 wherein the solubilizing buffer system is provided as a solid or solution.

17. The process of claim 19 wherein the solubilizing buffer system is selected from the group consisting of boric acid, sodium borate, potassium tetraborate, potassium metaborate, tris (hydoxymethyl)aminoethane, N,N-Bis(2-hydroxyethyl)-2-aminoethanesulfonic acid (BES), N,N-Bis(2-hydroxyethyl)glycines (BICINE), 3-(Cyclohexylamino)-1-propanesulfonic acid (4-(2-Hydroxyethyl)-1-piperazinepropanesulfonic acid (EPPS), 4-(2-Hydroxyethyl)piperazine-1-ethanesulfonic acid (HEPES), 2-(N-Morpholino)ethanesulfonic acid hydrate (MES), morpholinopropanesulfonic acid (MOPS), 1,4-Piperazinediethanesulfonic acid (PIPES), [(2-Hydroxy-1,1-bis(hydroxymethyl)ethyl)amino]-1-propanesulfonic acid (TAPS), 2-[(2-Hydroxy-1,1-bis(hydroxymethyl)ethyl)amino]ethanesulfonic acid (TES), and N-[Tris(hydroxymethyl)methyl]glycines (TRICINE), EDTA and mixtures thereof.
